(19) United States
(12) Patent Application Publication
(10) Pub. No.: US 2026/0278717 A1
(43) Pub. Date: Sep. 17, 2026

(54) SYSTEM AND METHOD FOR ESTATE RESOLUTION

(71) Applicant: Estate Servicing Hub LLC, Minneapolis, MN (US)

(72) Inventor: Jodi L. Wynblatt, Minneapolis, MN (US)

(21) Appl. No.: 19/076,727

(22) Filed: Mar. 11, 2025

(51) Int. Cl. G06Q 50/18; G06Q 10/10

(52) U.S. Cl. CPC G06Q 50/186; G06Q 10/10

(57) ABSTRACT

A system and method for estate resolution, more specifically, to a system and method for streamlining resolution of a person's accounts with businesses after death. The system and method facilitate legal resolution by a responsible party of decedent accounts across multiple account-holding companies. The system and method provide a hub for responsible parties associated with an account and account-holding companies such that a responsible party can provide required documentation a single time and that documentation can flow to multiple account-holding companies.

### FIELD OF THE INVENTION

The present disclosure relates to novel and advantageous systems and methods for estate resolution. Particularly, the present disclosure relates to novel and advantageous systems and methods for legal resolution of decedent accounts as part of estate resolution. More particularly, the present disclosure relates to novel and advantageous systems and methods for legal resolution of decedent accounts as part of estate resolution and tracking of such account resolution.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

When a person (the decedent) dies, it is necessary for their accounts to be closed or transitioned. A legal representative is appointed for the decedent and is responsible for closing or transitioning the accounts in a process referred to as estate resolution. The legal representative gathers estate-related documents, identifies accounts to be resolved, organizes the accounts, and gathers account details.

Current methods of estate resolution are manual and time-consuming. The process can often last several months or longer. Steps include: collecting information for every account held by the decedent; gathering contact information for the business associated with each account (the account-holding business); collecting legal documents related to the decedent's estate; calling each account-holding business to report death of the decedent; gathering information required by each account-holding business to close or transition the account; mailing, faxing, or emailing the required information and documents to the account-holding business; following up regularly to determine if the required documents were received and/or if additional information or documents are required; mailing, faxing, or emailing required additional documents and information; and continuing to follow up until the account is resolved. In some instances, multiple people may need to execute one or more of these steps

When there are beneficiaries associated with an account, each beneficiary must individually contact the account-holding business, explain their relationship with the decedent, provide account information, and submit their own documentation and instructions.

Current methods for closing and resolving decedent accounts are also burdensome for the account-holding companies. The legal representative calls the account-holding business to report the death of an account holder and is routed to the estate resolution department. The estate resolution department gathers information from the legal representative such as identity and account information. The estate resolution department verifies that information. The estate resolution department gives the legal representative detailed instructions about what documentation is necessary. The legal representative then sends the required documentation (via fax, mail, email, or other) to the account holding business. The estate resolution department verifies the documentation internally. The legal representative then calls the estate resolution department to learn the status of the account and receive instructions if additional information is necessary. This is repeated until the account is resolved.

The shortcomings of existing methods are burdensome and multifold. Legal representatives and beneficiaries of the estate and need to gather and organize the records, including action items and status. This could be in a spreadsheet, in files, in stickies notes, as a pile of papers, or some other system they individually devise. Legal representatives and beneficiaries must call or otherwise contact each account-holding business individually. This is increasingly burdensome the more accounts a decedent owned. The status of account resolution for each account is obtained and updated manually by a legal representative by calling each account-holding business or waiting for an official communication, usually by mail. There is often a significant time lag since no update can be provided until, at least, the documents have been received and entered into a business' records. The time required to resolve each account can be extended significantly if it is found in follow up that additional documents and/or information are required. This is due to the need to prepare, submit, and wait for the receipt of the additional documents or information, as well as repeated follow up, until the account are resolved.

There is a lack of technological solutions in the area of estate resolution. Online platforms exist where a person can store important documents and information on the accounts they own for the use of heirs and legal representative after their death. These, however, simply provide the legal representative a listing of account information, reducing the burden of the first step in account resolution, but not affecting the actual closing or other resolution of the identified accounts.

Thus, there is a need in the art for a technical solution to streamline the settlement of decedent accounts.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to estate resolution and, more specifically, to a system and method for estate resolution that streamlines resolution of a person's accounts with businesses after death. The system described herein may be referred to as an Estate Servicing Hub (“ESH”).

In one embodiment, a system for account resolution of a decedent account comprising an account-holding company module and a responsible party module is provided. The company module is configured for an account-holding company to input required documents for account resolution. The responsible party module is configured for a responsible party to upload the required documents. Status of account resolution is tracked on the account-holding company module and shown on the responsible party module. The responsible party and the account-holding company can communicate via the responsible party module and the account-holding company module.

In some embodiments, a system and method for estate resolution enabling a responsible party to efficiently resolve accounts across multiple account-holding companies is provided. In general, account-holding companies across industries require much of the same information for account resolution when a customer dies. Responsible parties must go through the account resolution process with each company-repeated submitting the same documents, navigating different systems, and facing unnecessary complexity. The system and method provided herein facilitate a responsible party providing common documents and answering standard questions one time, with the documents and answers being pushed to all applicable businesses. It further guides a responsible party through account-holding company specific requirements to reduce complexity of the account resolution process.

The system and method facilitate resolution of multiple accounts with multiple account-holding companies. As is described more fully below, a responsible party inputs account-holding companies where accounts to be resolved are located. The responsible party uploads documents (many standard, such as a certificate of death) and answers questions. For documents and questions common to multiple account-holding companies, the documents and answers are pushed to or pulled by each account-holding company.

Each account-holding company can customize required questions and documents for estate resolution, to automate messaging to responsible parties, and to set up work-flow for processing account resolution requests.

The system and method enable responsible parties and account-holding companies to view status and action items and to engage in two-way communication.

The present disclosure, in one or more embodiments, additionally relates to While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates a block diagram of a system for estate resolution, in accordance with one embodiment.

FIG. 2 illustrates steps of a method of estate resolution, in accordance with one embodiment.

FIG. 3 illustrates settings for a Responsible Party account, in accordance with one embodiment.

FIG. 4 illustrates a responsible party dashboard upon account creation, in accordance with one embodiment.

FIG. 5a illustrates a popup as first presented to the responsible party for adding an account-holding company toa dashboard, in accordance with one embodiment.

FIG. 5b illustrates the popup of FIG. 5a with the responsible party having input an account-holding company for looking up.

FIG. 6a illustrates a responsible party dashboard after a responsible party has input one or more account-holding companies into the dashboard, in accordance with one embodiment.

FIG. 6b illustrates a screen for the responsible party to input an account of the responsible party (if estate planning) or decedent (if estate resolving), in accordance with one embodiment.

FIG. 6c illustrates the responsible party dashboard with an account-holding company selected after account information has been added for one or more accounts at the account-holding company, in accordance with one embodiment.

FIG. 7 illustrates aspects of a document vault, in accordance with one embodiment.

FIG. 8a illustrates a popup for uploading a document to the document vault, in accordance with one embodiment.

FIG. 8b illustrates the popup of FIG. 8a with the responsible party having selected a document to upload, in accordance with one embodiment.

FIG. 9 illustrates an actions item summary available through the responsible party dashboard, in accordance with one embodiment.

FIG. 10 illustrates an account-holding company module, in accordance with one embodiment.

FIG. 11 illustrates a dashboard of an account-holding company module, in accordance with one embodiment.

FIG. 12a illustrates a configuration section of an account-holding company module with a business info tab selected, in accordance with one embodiment.

FIG. 12b illustrates a configuration section of an account-holding company module with a process info tab selected, in accordance with one embodiment.

FIG. 12c illustrates aspects of a configuration section of an account-holding company module, in accordance with one embodiment.

FIG. 12d illustrates aspects of a configuration section of an account-holding company module, in accordance with one embodiment.

FIG. 12e illustrates aspects of a configuration section of an account-holding company module, in accordance with one embodiment.

FIG. 12f illustrates aspects of a configuration section of an account-holding company module, in accordance with one embodiment.

FIG. 12g illustrates aspects of a configuration section of an account-holding company module, in accordance with one embodiment.

FIG. 12h illustrates example field settings for an account-holding company, in accordance with one embodiment.

FIG. 12i illustrates a configuration section of an account-holding company module with a required document tab selected, in accordance with one embodiment.

FIG. 12j illustrates a configuration section of an account-holding company module with a notifications tab selected, in accordance with one embodiment.

FIG. 13a illustrates a popup that appears when the account-holding company adds a field and identifies that the field is a checkbox, in accordance with one embodiment.

FIG. 13b illustrates a popup that appears when the account-holding company adds a field and identifies that the field as a conditional field, in accordance with one embodiment.

FIG. 13c illustrates a popup that appears when the account-holding company adds a field and identifies that the field is a dropdown, in accordance with one embodiment.

FIG. 13d illustrates a popup that appears when the account-holding company adds a field and identifies that the field is a long answer, in accordance with one embodiment.

FIG. 13e illustrates a popup that appears when the account-holding company adds a field and identifies that the field is a multiple choice, in accordance with one embodiment.

FIG. 13f illustrates a popup that appears when the account-holding company adds a field and identifies that the field is a short answer, in accordance with one embodiment.

FIG. 14a illustrates a popup prompting the account-holding company to identify the type of document that is required, in accordance with one embodiment.

FIG. 14b illustrates a popup enabling the account-holding company to add a proprietary document or form, in accordance with one embodiment.

FIG. 15a illustrates a decedent folders section of an account-holding company module, in accordance with one embodiment.

FIG. 15b illustrates an example of a decedent folders flow chart, in accordance with one embodiment.

FIG. 16a is a table illustrating aspects of prior art estate resolution versus estate resolution in accordance with the present invention from a responsible party perspective.

FIG. 16b is a table illustrating aspects of prior art estate resolution versus estate resolution in accordance with the present invention from an account-holding business perspective.

### DETAILED DESCRIPTION

The present disclosure relates to novel and advantageous systems and methods for estate resolution. Particularly, the present disclosure relates to novel and advantageous systems and methods for legal resolution of decedent accounts as part of estate resolution. More particularly, the present disclosure relates to novel and advantageous systems and methods for legal resolution of decedent accounts as part of estate resolution and tracking of such account resolution.

The invention generally relates to estate resolution and, more specifically, to a system and method for estate resolution that streamlines resolution of a person's accounts with businesses after death. The system described herein may be referred to as an Estate Servicing Hub (“ESH”).

The system and method facilitate resolution of multiple accounts with multiple account-holding companies. As is described more fully below, a responsible party inputs account-holding companies where accounts to be resolved are located. The responsible party uploads documents (many standard, such as a certificate of death) and answers questions. For documents and questions common to multiple account-holding companies, the documents and answers are pushed to or pulled by each account-holding company.

Each account-holding company can customize required questions and documents for estate resolution, to automate messaging to responsible parties, and to set up work-flow for processing account resolution requests.

The system and method enable responsible parties and account-holding companies to view status and action items and to engage in two-way communication.

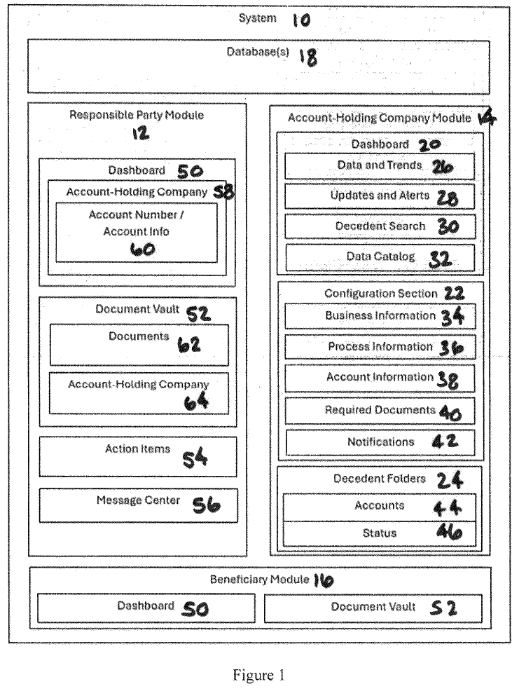

FIG. 1 illustrates a block diagram of a system for estate resolution 10, in accordance with one embodiment. The system acts as a hub for a responsible party and an account-holding company, and facilitates communication and transfer of data therebetween to facilitate estate resolution. In some embodiments, the system further facilitates communication between a beneficiary and an account-holding company.

The system may include an account holder-side module, referred to as the responsible party module 12, and an account-holding company-side module, referred to as a an account-holding company module 14 or a business module. In some embodiments, a beneficiary module 16 may be provided. Alternatively, the responsible party module may have configurations for use by a beneficiary. The system further includes at least one database 18 for storing information input by and documents uploaded by a responsible party, a beneficiary, and/or an account-holding company. While a database is specifically referenced, any suitable type of storage or memory may be used.

The account-holding company module 14 may include a dashboard 20, a configuration section 22, and decedent folders 24. The dashboard 20 may provide data and trends 26, updates and alerts 28, decedent search functionality 30, and a data catalog 32. The configuration section 22 may facilitate input of business information 34, process information 36, account information 38, required documents 40, and notifications 42. Decedent folders 24 may present accounts 44 and statuses of the accounts 46.

The responsible party module 12 may include a dashboard 50, a document vault 52, an action items page 54, and a message center 56. The dashboard 50 may facilitate input of an account-holding company 58 and associated account numbers and information 60 and may present detail during the estate resolution process. The document vault 52 may hold documents 62 uploaded by the responsible party and show their correlation to and status with an account-holding company 64. The action items page 54 may illustrates actions to be taken and/or status of such actions. The message center 56 may present messages from, for example, an account-holding company.

The beneficiary module 16 may be substantially similar to the responsible party module and may include a dashboard 50 and document vault 52, and optionally, an action items page and a message center. In some embodiments, the beneficiary module 16 may have less functionality than a responsible party module and may be used primarily for uploading information and documents.

The database(s) 18 may store documents responsible party account information, account-holding company account information, uploaded documents, and other information input or uploaded to the system.

The user of the responsible party module 12 may initially be an account holder using the module for estate planning purposes, and may transition to a legal representative using the module for estate resolution purposes, after the account holder's death. Alternatively, the account may be opened post-account holder death and the responsible party may originate as the legal representative of the account holder.

Resolution of decedent accounts is rule-based, being governed both by laws and individual policies of account-holding companies (also referred to herein as account-holding companies). The system guides a responsible party through the steps required for resolution of each account. This may include those required by legal rules and/or business-specific requirements, to the extent input by an account-holding company.

Using the disclosed system, a responsible party can input account details about accounts to be resolved during the estate resolution process. An account-holding company can input required documents and other information relating to account resolution for accounts they hold. The system can link the responsible party and the corresponding account-holding business to facilitate account resolution after death of the person holding the accounts. More specifically, the system can communicate required documents to a responsible party and the responsible party can upload the required documents to the system. Status of account resolution may tracked on the business module and shown on the responsible party module; and the responsible party and the account-holding company can communicate via the responsible party module and the business module.

In some embodiments, the responsible party module 12 includes an account dashboard 50, a notification center including an action items page and a message center, and a document vault 52. Documents may be uploaded to the document vault. The account dashboard illustrates status of each account in the resolution process. Communication may be done through the account dashboard. In some embodiments, beneficiaries may create a beneficiary account. The beneficiary account may have a document vault and dashboard with access to all features needed to complete their part of the estate resolution process. The disclosed system 10 provides two-way communication between the responsible party and the account-holding company via the dashboard and notification center.

When it is desired to resolve an account, a responsible party starts the resolution process using the system. Estate resolution departments of account-holding companies receive pushed documents and required data, or can pull queued documents and data, as configured by them in their business profile. The estate resolution departments review the documents and can update the dashboard to add action items for the responsible party or beneficiary, as well as status updates.

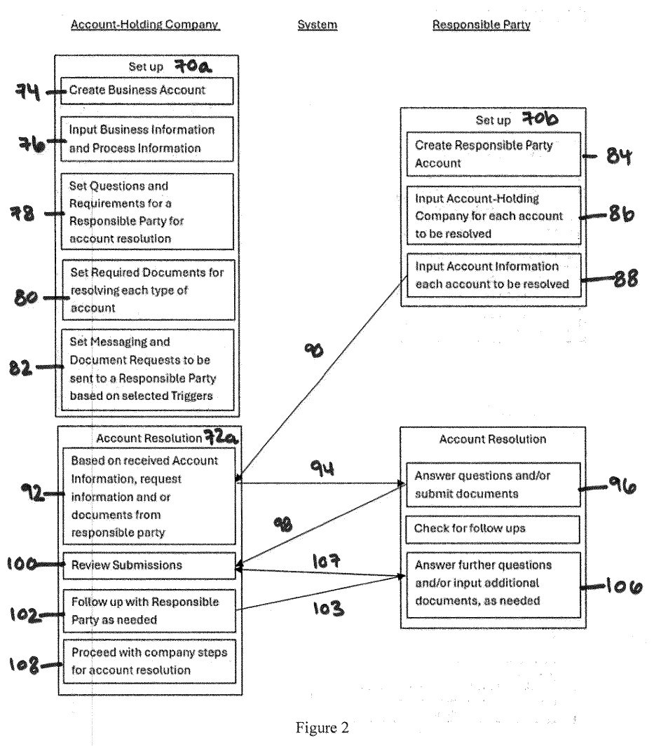

FIG. 2 illustrates steps of a method of estate resolution, in accordance with one embodiment. In this context, responsible party is intended to include beneficiary and a beneficiary's steps in estate resolution may include some or all of the discussed steps of the responsible party as appropriate.

For each of the account-holding company and the responsible party, steps for estate resolution include a set up stage 70a, 70b and an account resolution stage 72a, 72b. The set up stage 70a, 70b for each will be addressed first.

On the account-holding company side, during the set up stage, an account-holding company creates a business account 74. The account-holding company creates a profile using the configuration section of the account-holding company module.

The account-holding company inputs business information and process information 76. Business information may include business name, logo, estate care phone number, estate care addresses, estate care links, etc. Process information may comprise company specific account resolution information. This can include details about the account-holding company's account resolution process, including an expected timeline, required documents, proprietary forms, and questions.

The account-holding company sets questions and requirements for a responsible party for accomplishing account resolution 78. The account-holding company further sets what documents are required for resolving what type of account 80. Required documents may vary based on the type of account to be resolved for example utility companies and banks may require different documents. Further, banks may require different documents depending on what type of account is being resolved. In some embodiments, the account-holding company may input proprietary forms for filling out by the responsible party. The input required documents, proprietary forms, and questions can flow to a responsible party based on accounts to be resolved.

The account-holding company may further create messaging and document requests to be send to a responsible party or beneficiary based on selected triggers 82.

The account-holding company sets up their work-flow for processing in-coming account resolution requests. The account-holding company may automate standard dashboard/notification center messaging.

On the responsible party side, during the set up stage, a responsible party creates a responsible party profile or account 84. In this context, responsible parties may include the account holder (as part of estate planning) or a legal representative of the account holder. In association with the responsible party profile, the responsible party inputs account details for each account that needs or will need resolution.

The responsible party inputs the relevant account-holding company for each account to be resolved 86. The responsible party further inputs account information relating to each account to be resolved 88. This information may include account type, account number, etc.

If a responsible party attempts to upload information about an account held by an account-holding company that does not have a business profile on the Estate Servicing Hub, the responsible party can send a notification to the account-holding company requesting that they join the Estate Servicing Hub.

Turning now to the account resolution stage 72a, 72b, the system facilitates information flow and communication between the responsible party and the beneficiary. FIG. 2 illustrates steps of estate resolution using the system and data flow between a responsible party and account-holding company.

The system communicates to the applicable account-holding company when a responsible user has input a to-be-resolved account at the account-holding company. Based on the received account information, the account-holding company requests information and documents from the responsible party 92. It is to be appreciated that this request may be automated based on the account-holding company's configuration selections during the set up stage.

The system communicates 94 the information and document requests to the responsible party. The responsible party answers questions and/or uploads documents in response 96 and the system communicates 98 the answers and documents to the account-holding company. It is to be appreciated that when an account-holding company requests the same information and/or documents for multiple accounts, or when a different account-holding company requests the same information and/or document, the system may be configured to automatically correlate previous answers and documents to the new request(s).

The account-holding company reviews the submissions for completeness 100. If a question is not answered or a document is not submitted, the account-holding company follows up with the responsible party 102. The system communicates 103 follow ups from the account-holding company to the responsible party. For example, if a responsible party does not answer a question required by an account-holding company, answering that question will be added to the action items in the applicable account-holding company tab on the responsible party or beneficiary dashboard (discussed below). The system may be configured such that notification of death and/or one or more required documents will not be sent to that account-holding company until all required questions have been answered. It is to be appreciated that the account-holding company review and follow up may be automated by the system. The responsible party provides further information and/or documents in response to the follow up 106 and the system communicates 107 the further information and/or documents to the account-holding company.

An account-holding company estate resolution department reviews documents as standard for their organization and proceeds with resolution in accordance with their process flow 108.

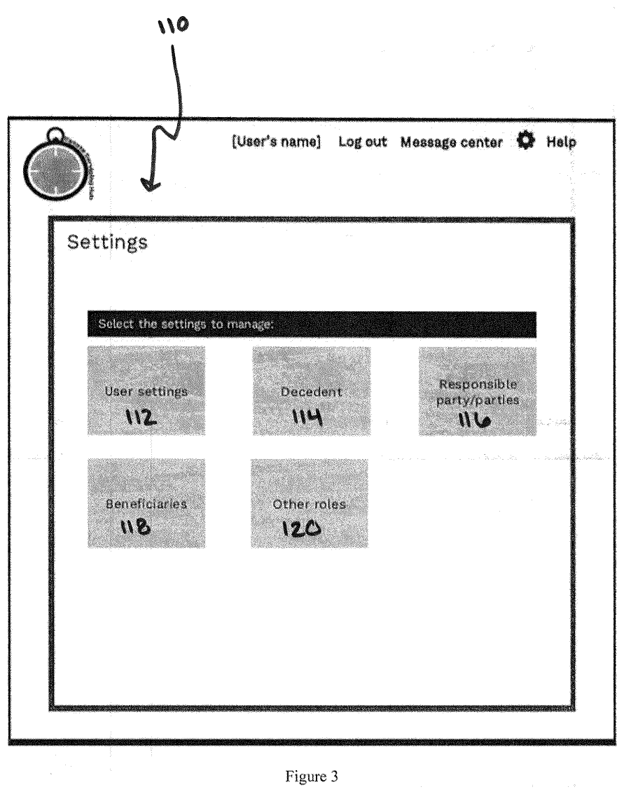

FIG. 3 illustrates settings 110 for a responsible party account, in accordance with one embodiment. As shown, the responsible party account may include information about a User 112, a Decedent 114, a Responsible Party or Responsible Parties 116, Beneficiaries 118, and Other Roles 120. In various circumstances, the same person may fulfill multiple of these roles.

User settings include standard account management features such as email, password, username, etc. The user settings may appear in both the responsible party and the beneficiary settings.

Decedent settings 114 include legal required information regarding the decedent (or account-holding person). The decedent settings may appear in the responsible party settings only.

Responsible party settings 116 include legal required information to evidence that a party is the legally authorized person for resolving a decedent's accounts. If documents are required as such evidence, the required document may be communicate to the responsible party and the responsible party may prompted to upload such document. The responsible party information may be appear in the responsible party settings only.

The Beneficiaries Settings 118 allow a user, such as a responsible party, to add people or entities who have been designated by the decedent as beneficiaries, as well as their contact information. When a beneficiary is input, the system may contact the beneficiary to prompt them to create an account to participate in the estate resolution process. This information may appear in the Responsible Party settings only.

The Other Roles settings 120 may be used where a user adds information about and invites others to see or act on the account. This may be used to allow an estate lawyer of the decedent to view detail of the account and status of the estate resolution process, for example. They may also facilitate the resolution process by uploading documents, including estate documents such as trust documents trust EIN documents probate documents, and the like. These documents may be uploaded to the responsible party's document vault.

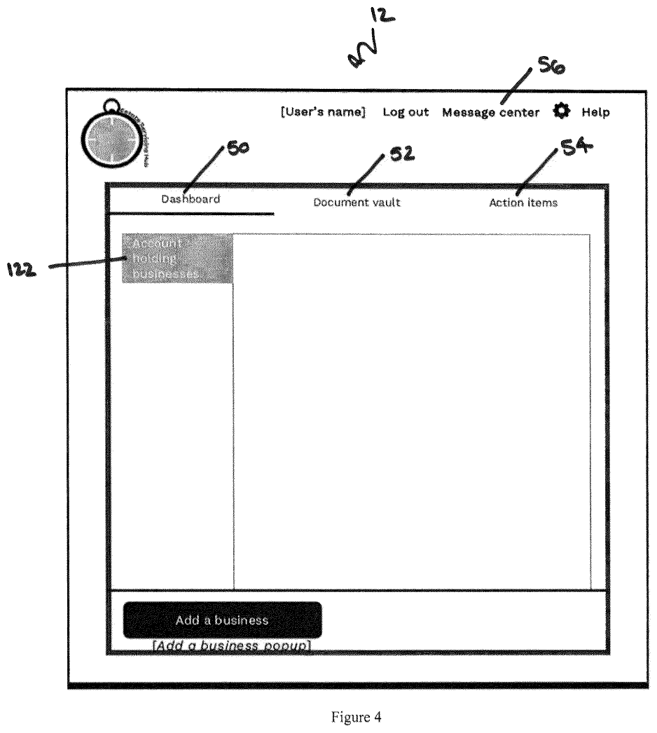

FIGS. 4-9 illustrate aspects of a responsible party module 12, in accordance with one embodiment. In some embodiments, the responsible party module may include a dashboard 50, a document vault 52, an action items listing 54, and a message center 56. As shown, tabs for navigating to the document vault or action items listing may be provided. The dashboard lists account-holding companies and the accounts of the decedent held by such account-holding company. The document vault lists documents required for resolution of various accounts, can associate those documents with specific account-holding companies, and indicates status of the document (required, uploaded, sent, received, etc.).

FIGS. 4-6c illustrate aspects of a responsible party dashboard 50, in accordance with one embodiment. It is to be appreciated that a beneficiary dashboard may include various of the items provided on the responsible party dashboard corresponding with required input from the beneficiary. The beneficiary dashboard may be auto-populated with business and action items that pertain to them.

FIG. 4 illustrates a responsible party dashboard 50 upon account creation, in accordance with one embodiment. The dashboard 50 presents account-holding companies 122 of accounts for resolution. The responsible party dashboard may be empty upon account creation. The responsible party inputs businesses where they (if alive and doing estate planning) or the decedent (if after death and doing estate resolution) hold accounts.

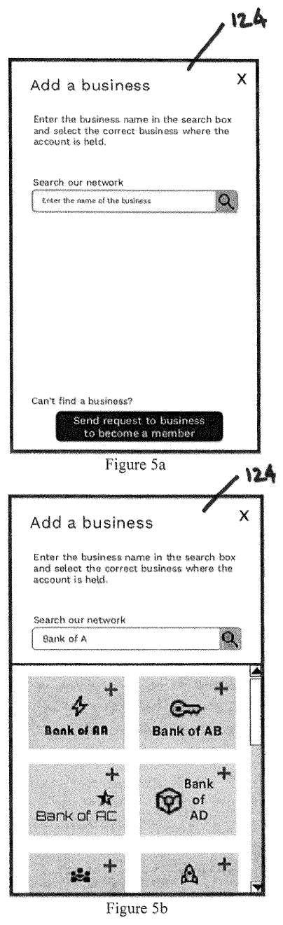

FIGS. 5a and 5b illustrates a popup 124 for adding an account-holding company to the dashboard, in accordance with one embodiment. FIG. 5a illustrates the popup as first presented to the responsible party. FIG. 5b illustrates the popup with the responsible party having input an account-holding company for looking up. Upon entering of the account-holding company, if the desired company does not appear, it likely does not have an account and the user can send a request that the company become a member. It is to be appreciated that the popup of FIGS. 5a and 5b are merely examples of a mechanism for facilitating input of account-holding companies into the responsible party dashboard.

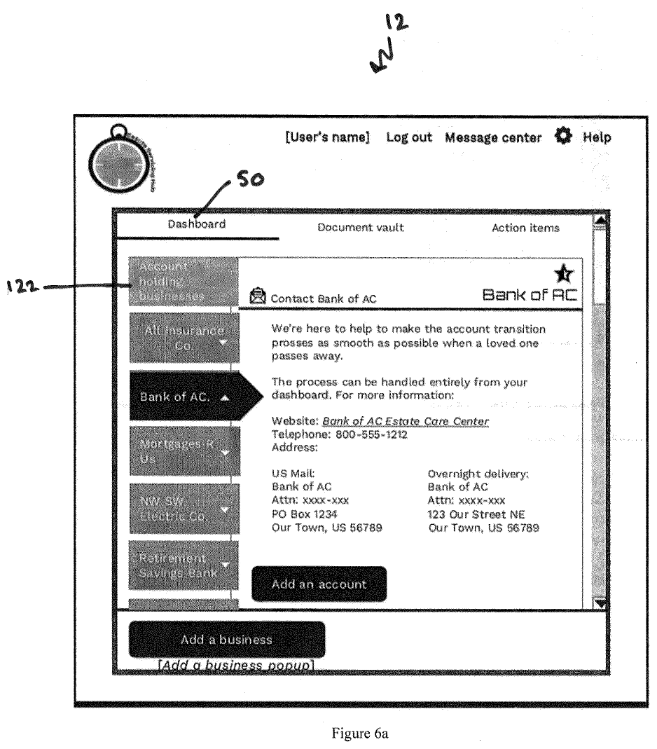

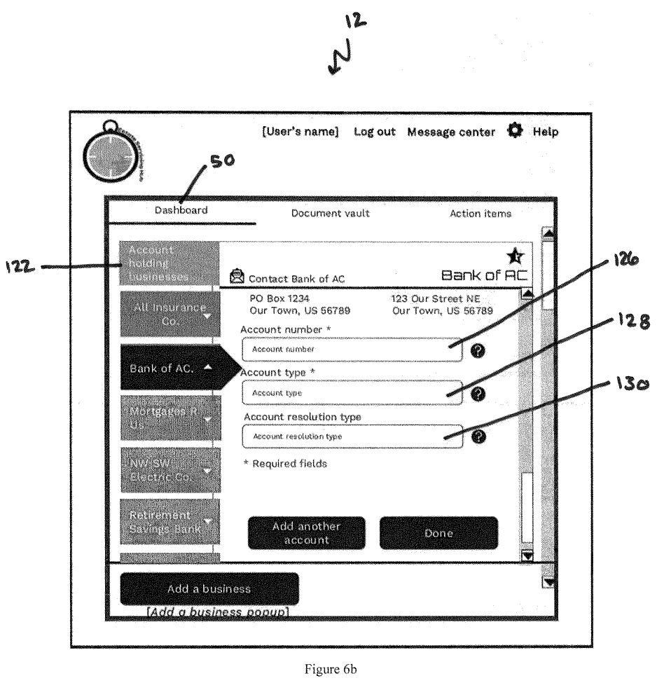

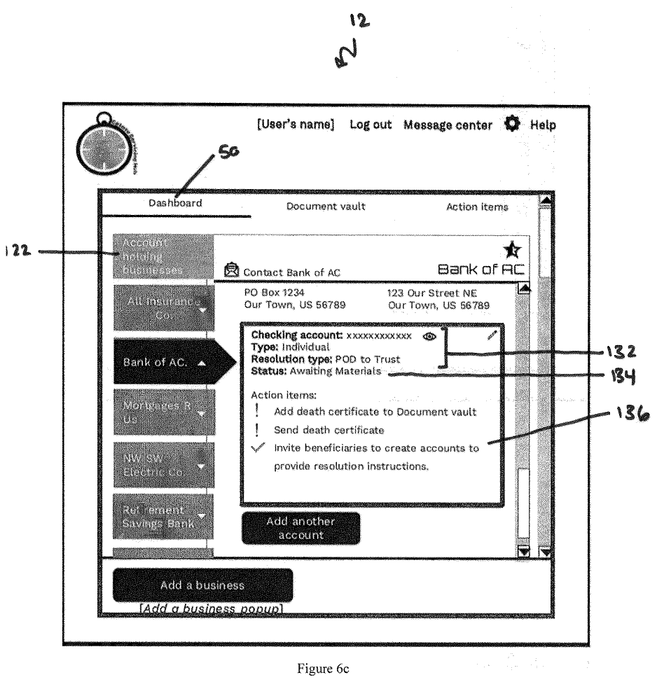

FIG. 6a illustrates a responsible party dashboard 50 after a responsible party has input one or more account-holding companies 122 into the dashboard 50, in accordance with one embodiment. From the dashboard, the responsible party may select an account-holding company to expand detail about the account-holding business. This detail may include information about the account-holding business that was input by the account-holding business to their account.

FIG. 6b illustrates a screen for the responsible party to input an account of the responsible party (if estate planning) or decedent (if estate resolving), in accordance with one embodiment. The responsible party may input detail about one or more accounts at each account-holding company. This information may include account number 126, account type 128, and account resolution type 130 (e.g. individual, joint, trust, POD/TOD).

FIG. 6c illustrates the responsible party dashboard with an account-holding company selected after account information has been added for one or more accounts at the account-holding company, in accordance with one embodiment. For each responsible party account at the account-holding company, account information 132, status 134, and action items 136 may be displayed. Account information may include account number, type of account, and resolution type. Status may include awaiting materials, materials received, etc. Action items may include add document to document vault, send document, invite beneficiaries to create accounts to provide resolution instructions, etc.

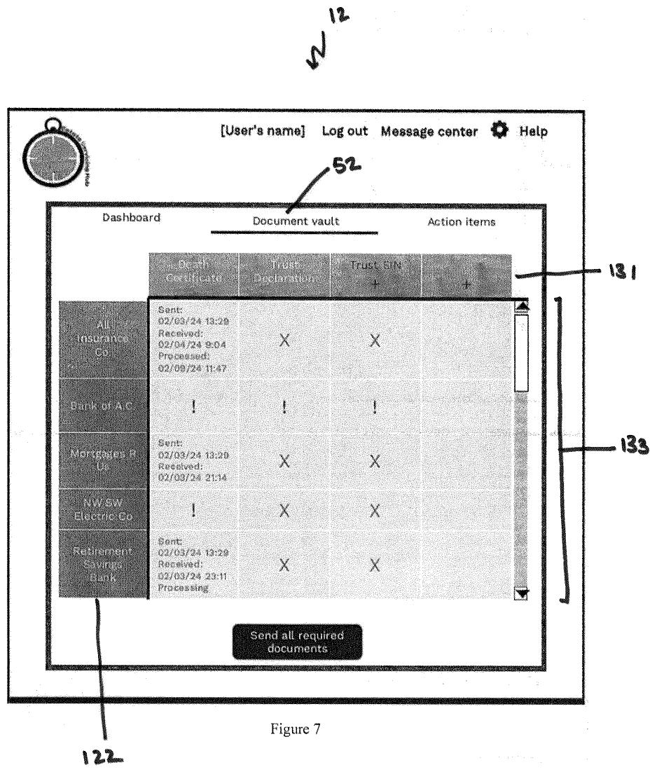

FIG. 7 illustrates aspects of a document vault 52, in accordance with one embodiment. The document vault 52 may be a responsible party document vault or a beneficiary document vault. The document vault 52 lists each account-holding company 122, the required documents 131 for resolution of each account, and the statuses 133 of each.

The document vault is where a user (such as a responsible party or a beneficiary) uploads documents required to resolve accounts. Documents may be required by all account-holding companies (such as documents required by law) or by some account-holding companies (such as documents required in accordance with individual company policy). In addition to holding and providing access to a document, the document vault displays status information and action items for each document for each account-holding company. Status may show, for example, whether a document has been uploaded to the document vault, is still needed for an account-holding company, or has been sent to an account-holding company. From the document vault, a responsible party may select to send or submit a document to an account-holding company.

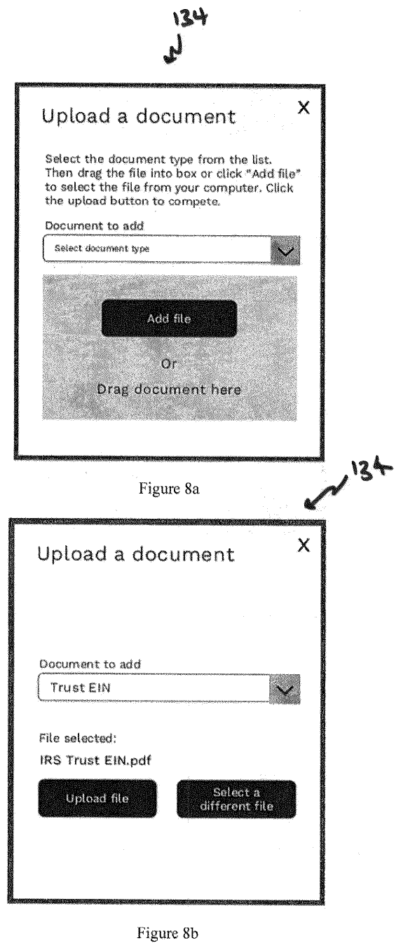

FIGS. 8a and 8b illustrates popups 134 for uploading a document to the document vault, in accordance with one embodiment. FIG. 8a illustrates the popup 134 as first presented to the responsible party. FIG. 8b illustrates the popup 134 with the responsible party having selected a document to upload, in accordance with one embodiment. It is to be appreciated that the popup of FIGS. 8a and 8b are merely examples of a mechanism for facilitating input of account-holding companies into the responsible party dashboard. After a document has been uploaded to the document vault, the name of the document may be added to the header of the document vault and its status relevant to account-holding companies shown.

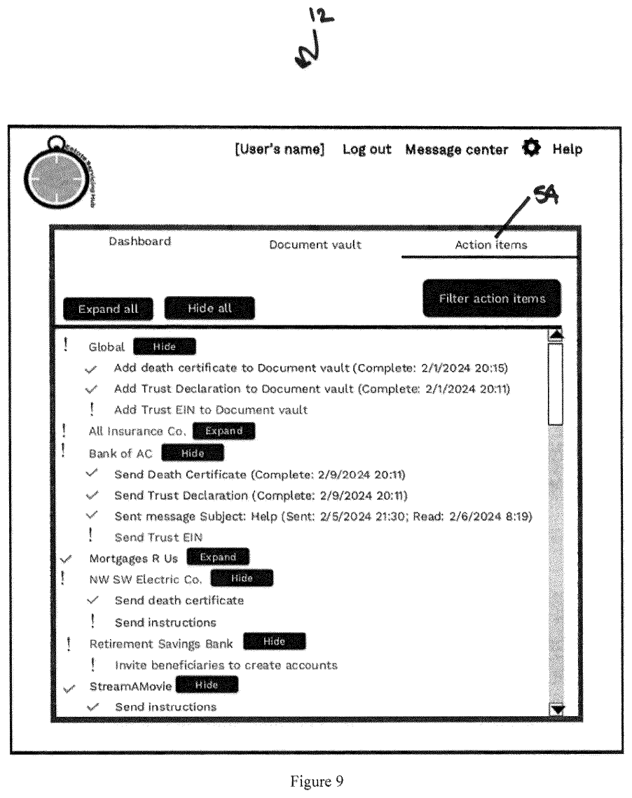

FIG. 9 illustrates an actions item summary 54 available in the responsible party module 12, in accordance with one embodiment. An actions item summary may also be available in a beneficiary module. The action items summary 54 is a summary of all actions the responsible party needs to complete as well as two-way communications with companies. A record may be kept indicating if the action is complete or still pending.

In some embodiments, the responsible party may be able to navigate to resolve the action. For example, if the responsible party selects “Send instructions” under an account, a form message will open, letting the responsible party select how they want to resolve the account. For example, the form can have the responsible user select “Cancel Stream AMovie account,” and then send that form to StreamAMovie. This may be tied to the responsible party message center.

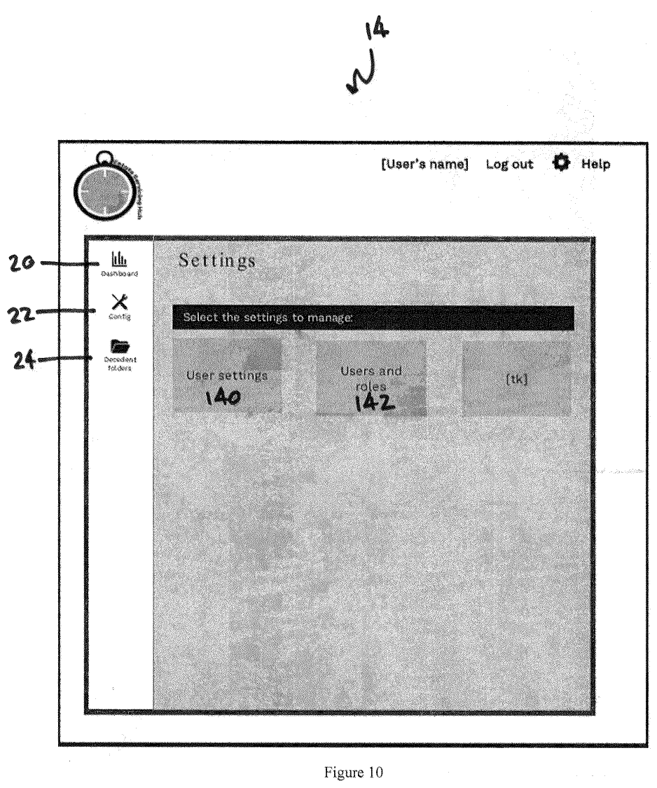

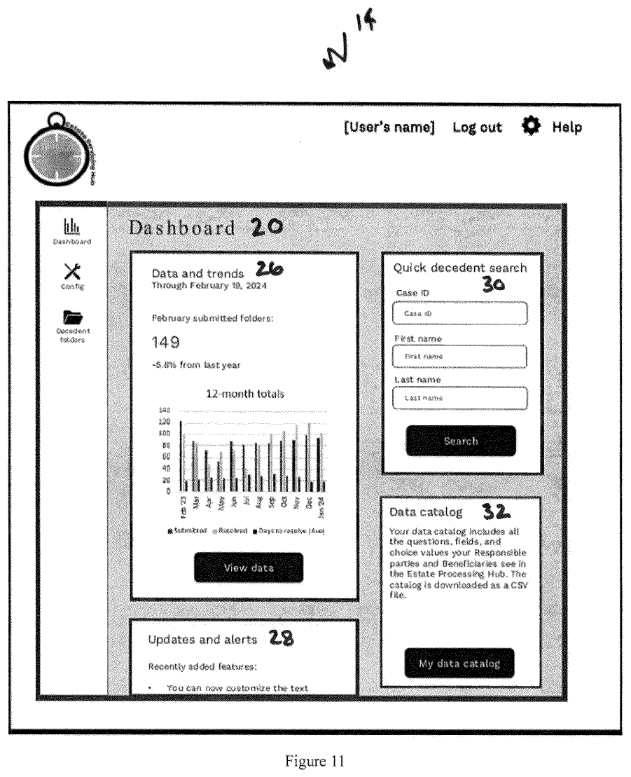

FIGS. 10-15b illustrate aspects of an account-holding company module 14, in accordance with one embodiment. Various aspects of the business module may be accessed by a primary business account user and other business users. An account-holding company module, including a dashboard 20, configuration section 22, and decedent folders 24 may be provided.

FIG. 10 illustrates aspects of an account-holding company module 14, in accordance with one embodiment. More specifically, FIG. 10 illustrates settings of the account-holding company module. The settings may include, for example, user settings 140, and users and roles 142. User settings 140 may include standard user setting management features such as email, password, username, etc. User settings may be shown for the settings of all user roles.

Users and roles 142 may be used by the primary business account, or other user granted authority to do so, to add users and define roles. Defining a user role grants permissions to a user based on the role.

FIG. 11 illustrates a dashboard 20 of an account-holding company module 14, in accordance with one embodiment. The dashboard 20 may present information and provide quick access to insights and most-used features. As shown, the dashboard 20 may display data and trends 26 as well as updates and alerts 28. The dashboard 20 may further provide access to decedent searching 30 and a data catalog 32.

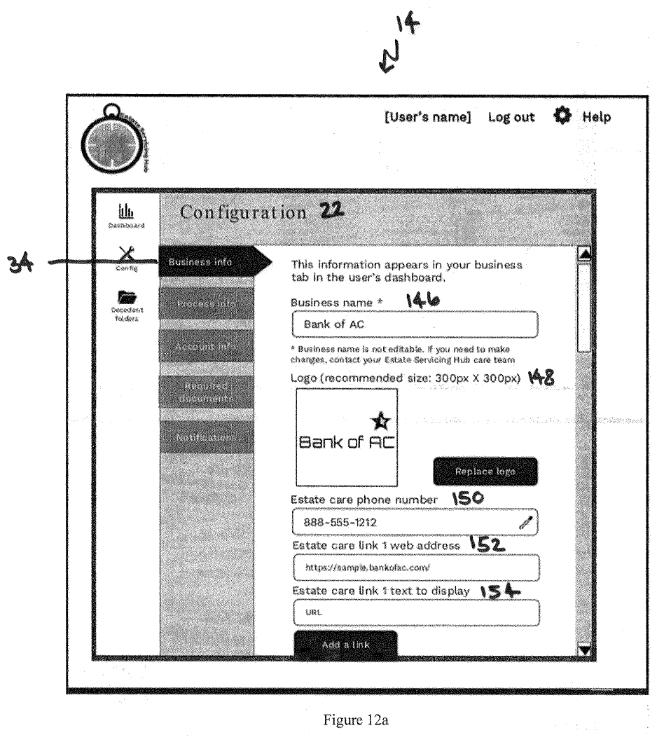

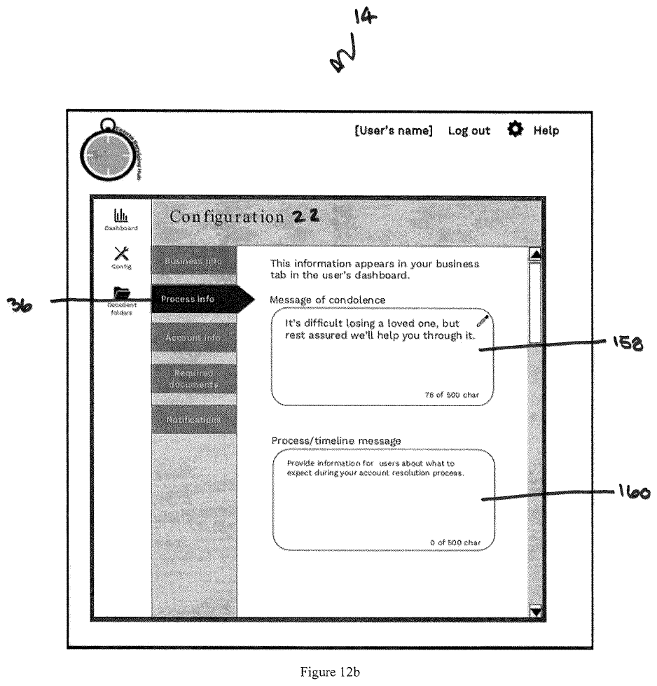

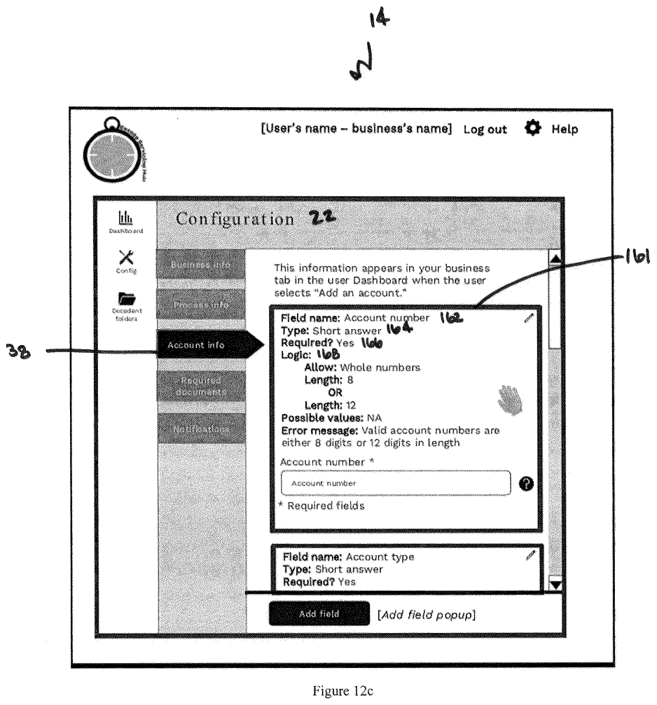

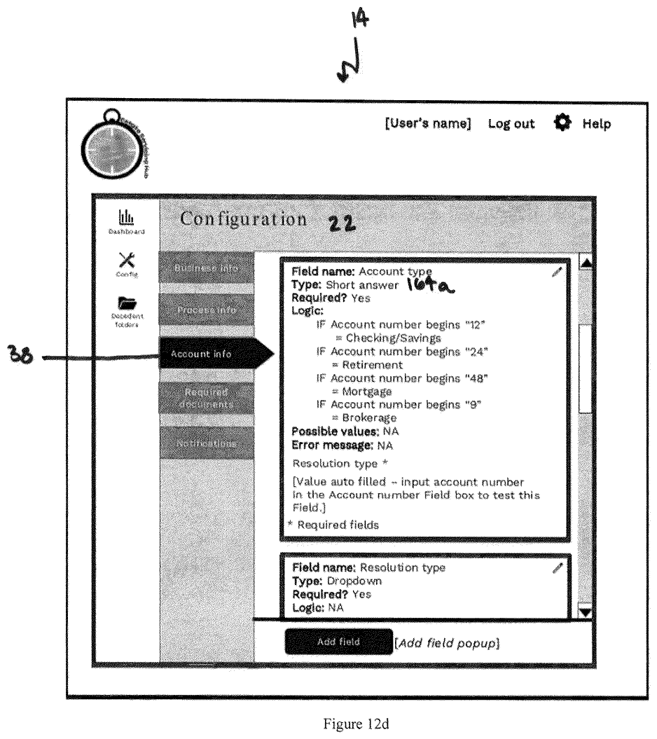

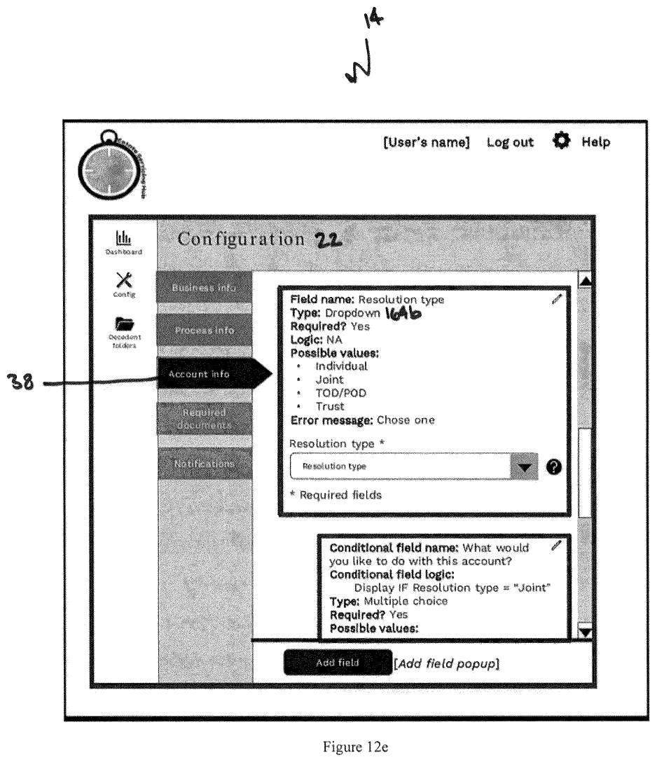

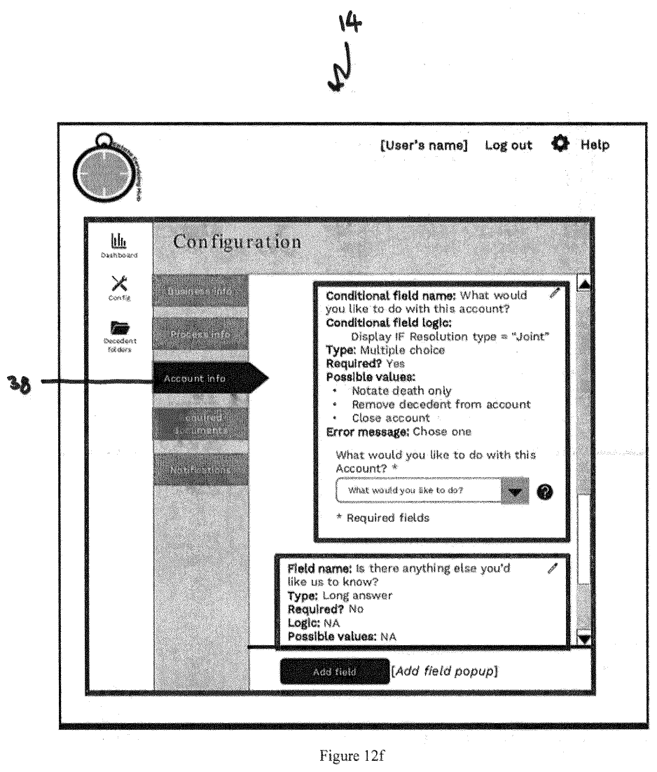

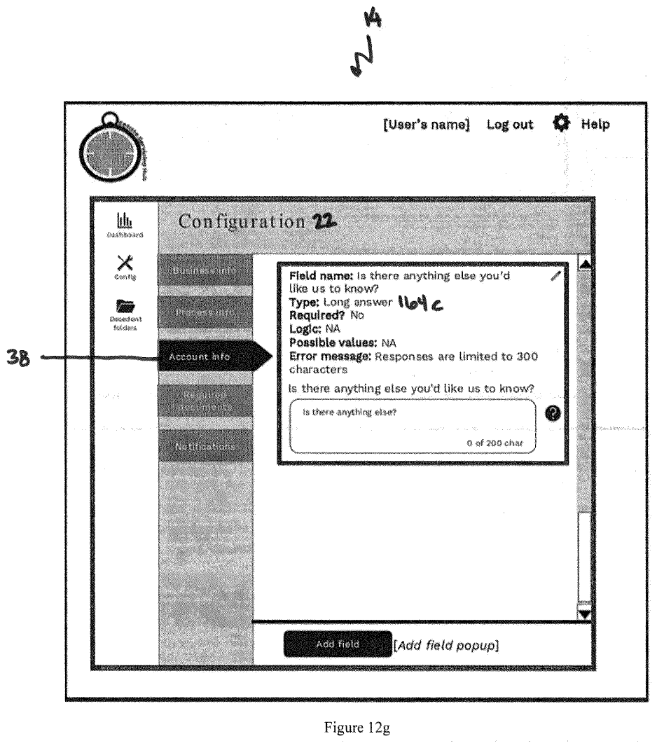

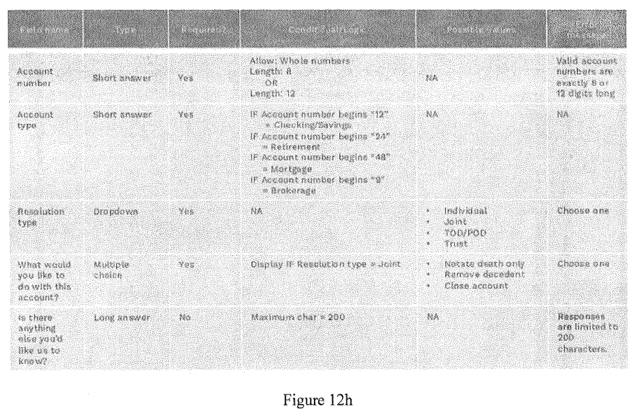

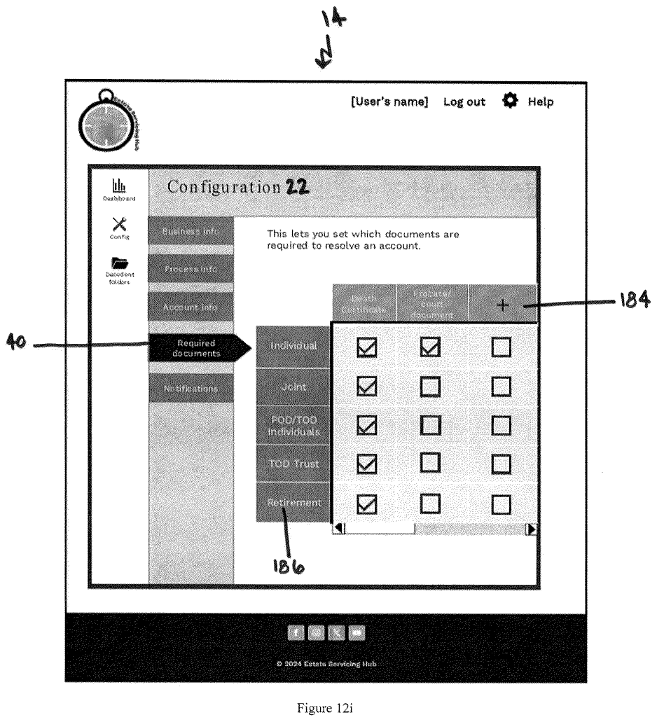

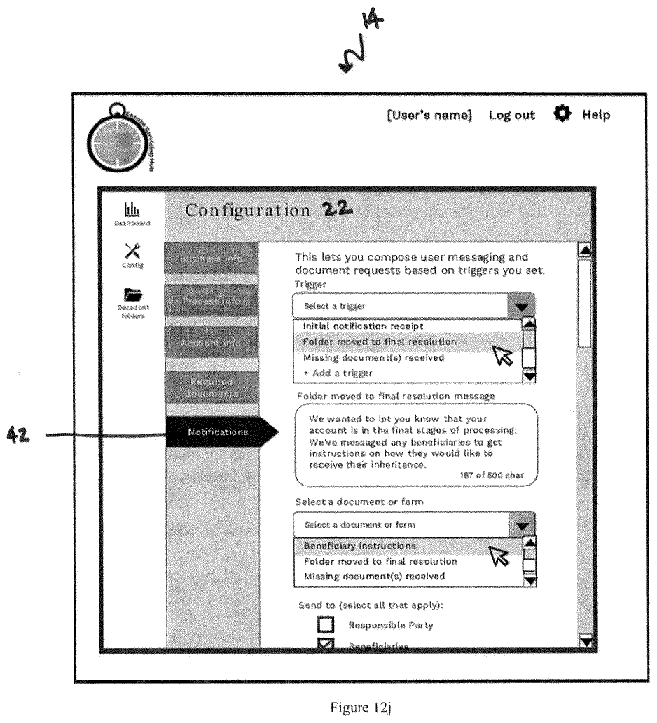

FIGS. 12a-12g, 12i, and 12j illustrates aspects of a configuration section of an account-holding company module. FIG. 12h illustrates example field settings for an account-holding company. As shown, the configuration section may include a business info tab 34, a process info tab 36, an account info tab 38, a required documents tab 40, and an notifications tab 42. It is to be appreciated that more or fewer tabs may be provided and that the information available through those tabs may be accessed in a different manner, with tabs being an example.

FIG. 12a illustrates a configuration section 22 of an account-holding company module 14 with a business info tab 34 selected, in accordance with one embodiment. This section may be used by an account-holding company to customize their messaging and requirements for resolving decedent accounts. The account-holding company can set and/or edit the information that a responsible party will see, such as business name 146, logo 148, estate care phone number 150, estate care address 152, estate care links 154, etc.

FIG. 12b illustrates a configuration section 22 of an account-holding company module 14 with a process info tab 36 selected, in accordance with one embodiment. This section may be used by an account-holding company to input detail about their account resolution process 158, including an expected timeline, and a message of condolence 160.

FIGS. 12c-12g illustrate aspects of a configuration section 22 of an account-holding company module 14 for adding a field 161 using the example field settings from FIG. 12h. This section may be used by an account-holding company to customize their messaging and requirements for resolving decedent accounts. FIG. 12d illustrates adding field having a short answer 164a. FIG. 12e illustrates adding a field having a dropdown 164b. FIG. 12f illustrates adding a conditional field. FIG. 12g illustrates adding a field having a long answer 164c.

An account-holding company can add fields/questions for a responsible party to see when they add an account to the responsible party module. The account-holding company may input field name 162, field type 164, whether completing the field is required 166, logic 168, help messages for each field, and autofill for each field. Example detail available to an account-holding company in adding such fields/questions is discussed below. Fields can be conditional and appear only if a responsible party or beneficiary gives a particular answer to a question from a different field.

Field names 162 may be input for any information requested by the account-holding company. These may include, for example, account number, account type, ownership, etc.

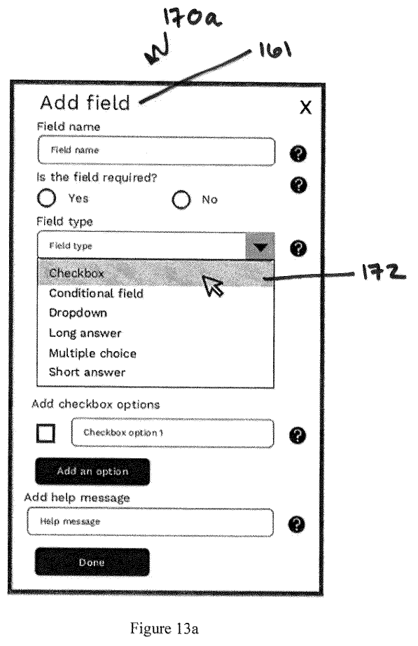

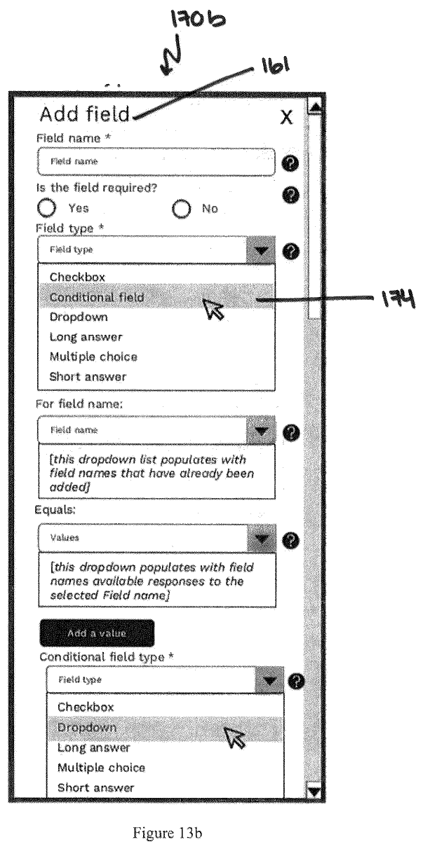

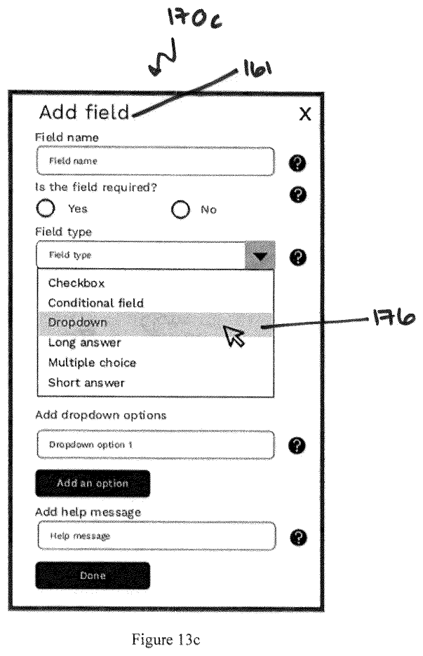

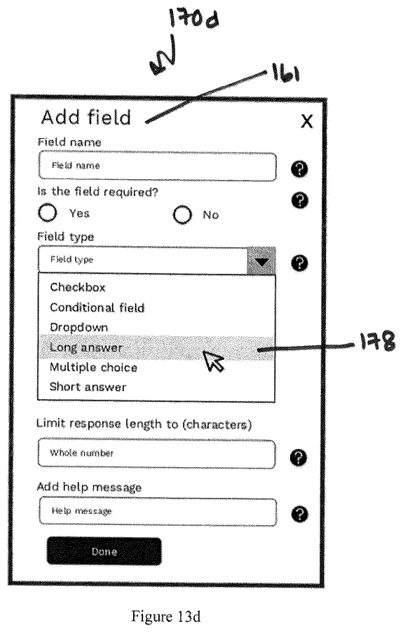

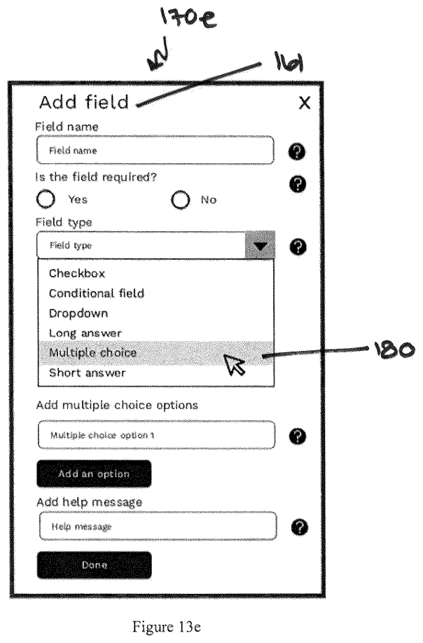

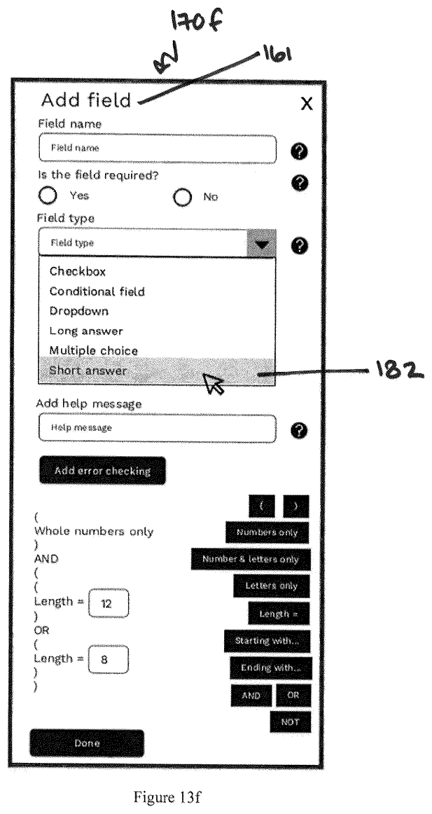

The account-holding company may select a type of field for the answer to be given by the responsible party. Types of field may include, for example, dropdown, multiple choice, checkboxes, short answer, long answer, condition. Process flow for the account-holding relating to types of field is discussed in relation to FIGS. 13a-13f.

Logic may comprise input error-checking using standard logic operators. For example, an account-holding company can set account numbers as valid only if they have exactly 12 digits. Multiple error-checking constraints may be input to any given field.

Autofill for a field may be based on logic and may be triggered to happen after a responsible party submits the initial notice of death. After data has been pulled from the account-holding company's database relating to accounts held by the decedent, data may be autofilled. As an example, if an account number begins with “1”, the value may be set to checking/savings whereas if an account number begins with “8”, the value may be set to brokerage.

FIGS. 13a-13f illustrates examples of process flow for adding fields best on the type of field selected by the account-holding company, in accordance with some embodiments. In the illustrated examples, popups appear for the field and the account-holding company is required to select the field type-for example checkbox, conditional, dropdown, long answer, multiple choice, or short answer. For each type of field, the account-holding company may be asked to provide a field name, indicate whether the field is required, and add a help message. It is to be appreciated that while FIGS. 13a-13f illustrate popups, these are merely examples of a mechanism for gathering information from the account-holding company to relating to required account information and other suitable mechanisms may be used.

FIG. 13a illustrates a popup 170a that appears when the account-holding company adds a field 161 and identifies that the field is a checkbox 172. When adding a checkbox field, the account-holding company is asked to add one or more checkbox options.

FIG. 13b illustrates a popup 170b that appears when the account-holding company adds a field 161 and identifies that the field as a conditional field 174. This can be used to add additional fields that only appear when a responsible party gives a particular response. The account-holding company is prompted to identify what field triggers the conditional field and what the response is that triggers the conditional field. For example, when a responsible party indicates a specific account type, conditional questions may be given to the responsible party associated with that account type.

FIG. 13c illustrates a popup 170c that appears when the account-holding company adds a field 161 and identifies that the field is a dropdown 176. When adding a dropdown field, the account-holding company is asked to add one or more dropdown options.

FIG. 13d illustrates a popup 170d that appears when the account-holding company adds a field 161 and identifies that the field is a long answer 178. When adding a long answer field, the account-holding company may limit the length of the long answer by inputting a whole number in response to limit response length.

FIG. 13e illustrates a popup 170e that appears when the account-holding company adds a field 161 and identifies that the field is a multiple choice 180. When adding a dropdown field, the account-holding company is asked to add one or more multiple choice options.

FIG. 13f illustrates a popup 170f that appears when the account-holding company adds a field 161 and identifies that the field is a short answer 182. When adding a short answer answer field, the account-holding company may add error checking that lets the account-holding company limit responsible party responses to those that are considered valid.

FIG. 12i illustrates a configuration section 22 of an account-holding company module 14 with a required document tab 40 selected, in accordance with one embodiment. This section may be used by an account-holding company to set what documents are needed from a responsible party and/or beneficiaries for account resolution. The required documents 184 may be based on the type of account 186 to be resolved.

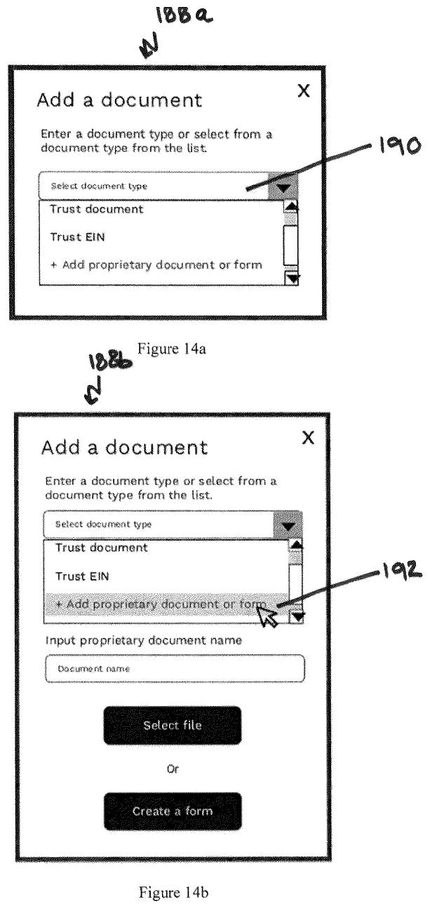

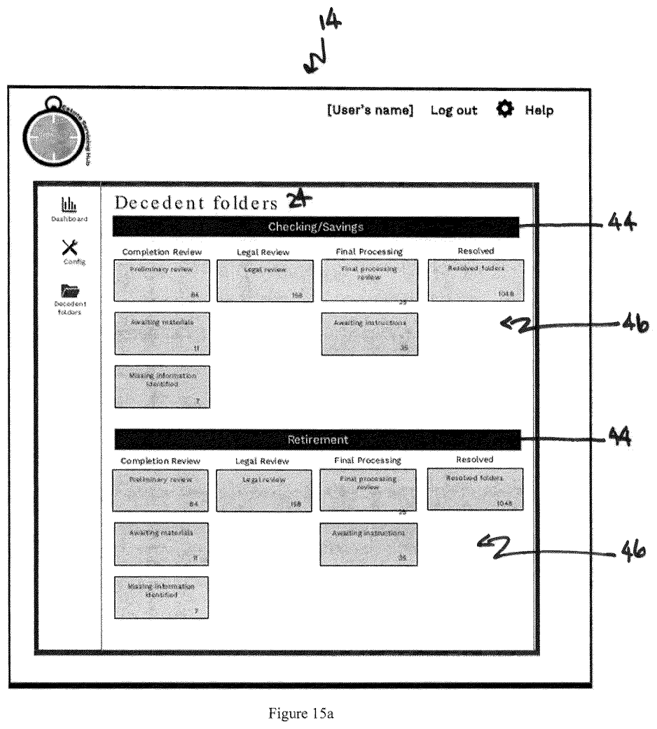

FIGS. 14a and 14b illustrate popups 188a, 188b that may be used for the account-holding company to add a required document. It is to be appreciated that while FIGS. 14a and 14b illustrate popups, these are merely examples of a mechanism for facilitating account-holding company input of required documents and other suitable mechanisms may be used.

FIG. 14a illustrates a popup 188a prompting the account-holding company to identify the type of document 190 that is required, in accordance with one embodiment. This may include standard documents such as a death certificate, probate/court document, trust document, trust EIN, etc. This may further include a proprietary document.

FIG. 14b illustrates a popup 188b enabling the account-holding company to add a proprietary document or form 192, in accordance with one embodiment. If the account-holding company has a proprietary document that needs to be submitted to the responsible party or beneficiary, they can create the document as a form that is added to the responsible party document vault or can upload a pre-existing document that is added to the responsible party document vault. If notarization is required, remote online notarization may be integrated in jurisdictions allowing such.

FIG. 12j illustrates a configuration section 22 of an account-holding company module 14 with a notifications tab 42 selected, in accordance with one embodiment. This section may be used by an account-holding company to compose messaging and requests to a responsible party or beneficiary based on triggers set by the account-holding company. These messages may appear in the action items tab on a responsible party or beneficiary dashboard. Any number and type of triggers may be set by the account-holding company to address a variety of events that could occur during the resolution process.

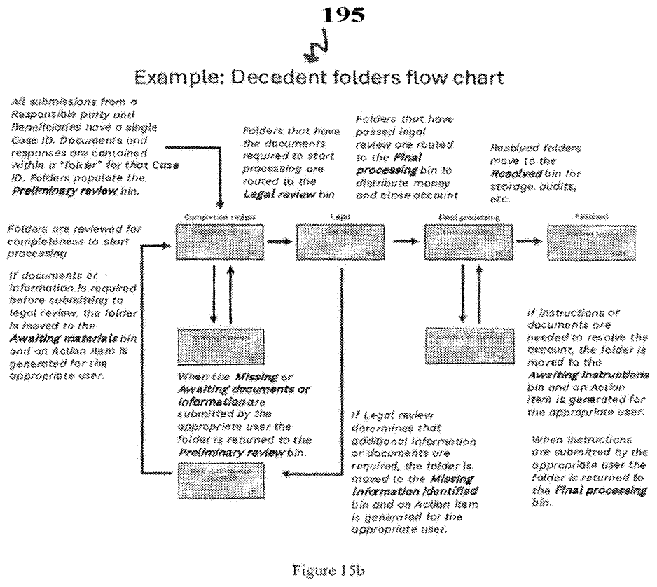

FIG. 15a illustrates a decedent folders section 24 of an account-holding company module 14, in accordance with one embodiment. The decedent folders section may be used by the account-holding company to intake and route submission from a responsible party and/or beneficiary. This section can be customized by an account-holding company based on their account resolution process flow. As shown, the decedent folder section 24 presents a decedent's accounts 44 and their resolution status 46.

FIG. 15b illustrates an example of a decedent folders flow chart 190, in accordance with one embodiment.

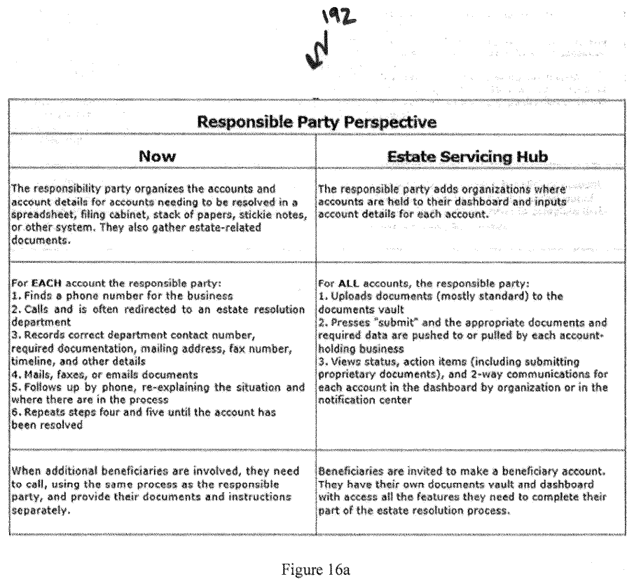

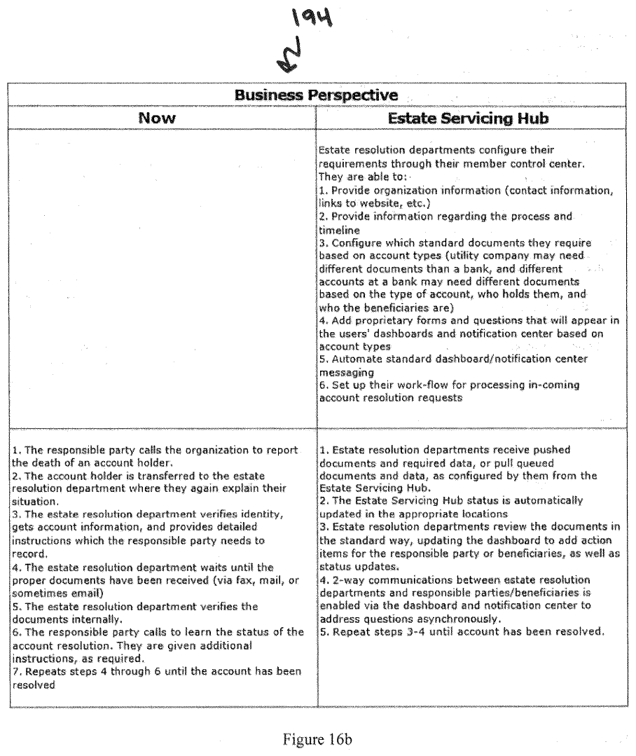

FIG. 16a is a table illustrating aspects of prior art estate resolution versus estate resolution in accordance with the present invention from a responsible party perspective. FIG. 16b is a table 194 illustrating aspects of prior art estate resolution versus estate resolution in accordance with the present invention from an account-holding business perspective. The disclosed system and method present a plurality of improvements over the current state of technology in estate resolution.

Generally speaking, account-holding companies across industries require much of the same information for account resolution when a customer dies. Responsible parties must go through the account resolution process with each company-repeated submitting the same documents, navigating different systems, and facing unnecessary complexity. The system and method provided herein facilitate a responsible party providing common documents and answering standard questions one time, with the documents and answers being pushed to all applicable businesses. It further guides a responsible party through account-holding company specific requirements to reduce complexity of the account resolution process.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a responsible party interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other responsible party input/output device for communicating with one or more responsible parties or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a responsible party, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A responsible party may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A computer-implemented system for account resolution of a decedent account, the system comprising:
at least one processor;
at least one database communicatively coupled to the at least one processor over a network;
an account-holding company module executed by the at least one processor and comprising a business dashboard, a configuration section, and decedent folders, the account-holding company module accessible to a plurality of account-holding companies;
a responsible party module executed by the at least one processor and communicatively coupled to the account-holding company module over the network, the responsible party module comprising a responsible party dashboard, a document vault, and an action items list, wherein a responsible party, after the death of the decedent, indicates an account-holding company holding an account to be resolved;
wherein the at least one database stores account resolution information entered by the account-holding company via the configuration section and documents uploaded by the responsible party via the document vault;
wherein the responsible party and the account-holding company communicate via the responsible party module and the account-holding company module, wherein
the communication includes the at least one processor automatically pushing required documents and information entered via the configuration section to the responsible party module, and the at least one processor automatically communicating documents and information uploaded by the responsible party to the plurality of account holding companies through the account-holding company module,
wherein said communication comprises said account-holding company receiving said account resolution information and documents and a request to resolve the account.

2. The system of claim 1, wherein the configuration section enables an account-holding company to input required documents and/or required information for resolving a type of account.

3. The system of claim 2, wherein the required documents and/or required information are communicated to the responsible party module upon selection of the type of account by the responsible party.

4. The system of claim 3, wherein the required documents and/or required information are dependent upon the type of account selected.

5. The system of claim 2, wherein the required documents and/or required information are submitted or uploaded by the responsible party and the required documents are saved to the document vault.

6. The system of claim 5, wherein the required documents are pushed to the account-holding company module following submission by the responsible party.

7. The system of claim 5, wherein responsible party indicates each of the plurality of account-holding companies holding an account to be resolved, and the required documents are pushed to each account-holding company.

8. The system of claim 1, wherein status of account resolution is tracked on the company module and shown on the responsible party module.

9. A computer-implemented method for account resolution of a decedent account for use by a responsible party to resolve accounts at one or more account-holding companies, the method performed by at least one processor communicatively coupled to a database over a network, the method comprising:
account-holding company set up including:
creating a business account;
inputting business information and process information;
setting questions and/or requirements for account resolution; and
setting required documents for account resolution;
responsible party set up including:
creating a responsible party account, and after the death of the decent;
(i) identifying the account-holding company for an account to be resolved; and
(ii) inputting account information relating to the account to be resolved;
account resolution including:
notifying each account-holding company of the account to be resolved, wherein the notifying is performed automatically by the at least one processor over the network;
communicating to the responsible party the questions, requirements, and/or required documents for account resolution, wherein the communicating is performed automatically by the at least one processor over the network; and
communicating to the account-holding company input information or documents, wherein the communicating to the account-holding company is performed automatically by the at least one processor over the network without requiring the responsible party to manually re-enter information or documents separately for each account-holding company, wherein said communication comprises said account-holding company receiving said account resolution information and documents and a request to resolve the account.

10. The method of claim 9, wherein the required documents are based on a type of account being resolved.

11. The method of claim 9, wherein account-holding company set up further includes setting messaging and/or document requests to be sent to the responsible party based on a trigger.

12. A computer-implemented method for account resolution of a decedent account for use by a responsible party to resolve accounts at one or more account-holding companies, the method performed by at least one processor communicatively coupled to a database over a network, the method comprising:
identifying a plurality of account-holding companies, each company possessing an account to be resolved, each company having requirements for account resolution, the requirements including at least one of answers to decedent related questions and effective documents,
inputting account information relating to the account to be resolved for each account holding company;
notifying, after the death of the decedent, each account-holding company of the account to be resolved, wherein the notifying is performed automatically by the at least one processor over the network;
communicating to the responsible party the questions, documents and/or any other requirements for account resolution, wherein the communicating is performed automatically by the at least one processor over the network; and
communicating to each account-holding company input information or documents, wherein the communicating to the account-holding company is performed automatically by the at least one processor over the network without requiring the responsible party to manually re-enter information or documents separately for each account-holding company, wherein said communication comprises said account-holding company receiving said account resolution information and documents and a request to resolve the account.

13. The system of claim 1, wherein the responsible party module is only accessible to the responsible party module after the death of the decedent, and wherein no account-holding company or account information for the decedent account may be input by the decedent prior to the death of the decedent.

14. The method of claim 9, wherein account resolution further comprises reviewing, by the account-holding company, the communicated input information or documents for completeness, and automatically communicating, by the at least one processor over the network, a follow-up request to the responsible party when the input information or documents are incomplete.

15. The method of claim 12, wherein account resolution further comprises reviewing, by the account-holding company, the communicated input information or documents for completeness, and automatically communicating, by the at least one processor over the network, a follow-up request to the responsible party when the input information or documents are incomplete
